(19) United States
(12) Patent Application Publication
(10) Pub. No.: US 2026/0255429 A1
(43) Pub. Date: Aug. 27, 2026

(54) APPARATUS, METHOD, AND COMPUTER PROGRAM

(71) Applicant: Nokia Technologies Oy, Espoo (FI)

(72) Inventors: Mads LAURIDSEN, Aalborg (DK); Jeroen WIGARD, Aalborg (DK); Srinivasan SELVAGANAPATHY, Bangalore (IN)

(21) Appl. No.: 18/872,592

(22) PCT Filed: Mar. 6, 2023
(86) PCT No.: PCT/EP2023/055538

§ 371 Date: Dec. 6, 2024

(30) Foreign Application Priority Data
Aug. 1, 2022 (FI) 20225695

(51) Int. Cl. H04W 76/27

(52) U.S. Cl. CPC H04W 76/27

(57) ABSTRACT

The disclosure relates to an apparatus comprising means for: suspending (700) a network connection via a first base station onboard a first vehicle; determining (702) that an apparatus context stored on the first base station onboard the first vehicle is expected to be available to a second base station onboard a second vehicle; and attempting (704) to resume the network connection via the second base station onboard the second vehicle.

### FIELD OF THE DISCLOSURE

The present disclosure relates to an apparatus, a method, and a computer program for attempting to resume a network connection via a base station onboard a vehicle.

### BACKGROUND

A communication system can be seen as a facility that enables communication sessions between two or more entities such as communication devices, base stations and/or other nodes by providing carriers between the various entities involved in the communications path.

The communication system may be a wireless communication system. Examples of wireless systems comprise public land mobile networks (PLMN) operating based on radio standards such as those provided by 3GPP, satellite based communication systems and different wireless local networks, for example wireless local area networks (WLAN). The wireless systems can typically be divided into cells, and are therefore often referred to as cellular systems.

The communication system and associated devices typically operate in accordance with a given standard or specification which sets out what the various entities associated with the system are permitted to do and how that should be achieved. Communication protocols and/or parameters which shall be used for the connection are also typically defined. Examples of standard are the so-called 5G standards.

### SUMMARY

According to an aspect there is provided an apparatus comprising means for: suspending a network connection via a first base station onboard a first vehicle;
determining that an apparatus context stored on the first base station onboard the first vehicle is expected to be available to a second base station onboard a second vehicle; and attempting to resume the network connection via the second base station onboard the second vehicle.

The second base station onboard the second vehicle may or may not be connected to the network. Different scenarios may be contemplated when attempting to resume the network connection via the second base station onboard the second vehicle.

In a scenario, the second base station may be connected to the network and may not previously have received and stored the apparatus context from the first base station. The second base station may now receive and store the apparatus context from the first base station. Thus, the apparatus context may be available to the second base station. Resuming the network connection via the second base station may be successful.

In another scenario, the second base station may be connected to the network and may previously have received and stored the apparatus context from the first base station. Thus, the apparatus context may be available to the second base station. Resuming the network connection via the second base station may be successful.

In another scenario, the second base station may not be connected to the network and may have previously be connected to the network. The second base station may have previously received and stored the apparatus context. Thus, the apparatus context may be available to the second base station. Resuming the network connection via the second base station may be successful.

In another scenario, the second base station may not be connected to the network and may or may not have previously be connected to the network. The second base station may not have previously received and stored the apparatus context. Thus, the apparatus context may not be available to the second base station Resuming the network connection via the second base station may not be successful.

The apparatus may comprise means for: receiving, from the first base station onboard the first vehicle a network connection release message; and wherein attempting to resume the network connection via the second base station onboard the second vehicle may comprise: sending, to the second base station onboard the second vehicle; a network connection resume message.

The network connection release message may comprise an identifier associated with the apparatus context; and wherein the network connection resume message may comprise the identifier associated with the apparatus context.

The apparatus may comprise means for: receiving, from the second base station onboard the second vehicle, a network connection resume complete message.

The apparatus may comprise means for detecting a failure to receive, from the second base station onboard the second vehicle, a network connection resume complete message; and storing the identifier associated with the apparatus context on the apparatus.

The apparatus may comprise means for: subsequently re-sending, to the second base station onboard the second vehicle; the network connection resume message comprising the identifier associated with the apparatus context.

The identifier may be stored with at least one of: a time parameter indicating how long the identifier is to be stored on the apparatus before deleting the identifier from the apparatus; a maximum number of tries parameter indicating a maximum number of times the apparatus is to subsequently re-send, to the second base station onboard the second vehicle; the network connection resume message comprising the identifier before deleting the identifier from the apparatus; or a maximum number of identifiers parameter indicating a maximum number of identifiers the apparatus is to store.

The apparatus may comprise means for: sending, to the second base station onboard the second vehicle, a network connection setup message not comprising the identifier associated with the apparatus context.

The apparatus may comprise means for: detecting a failure to receive, from the second base station onboard the second vehicle, a network connection setup complete message when the second base station onboard the second vehicle is not connected to the network.

The apparatus may comprise means for: detecting a failure to receive, from the second base station onboard the second vehicle, a network connection setup complete message; determining that the apparatus context stored on the first base station onboard the first vehicle is expected to be available to a third base station onboard a third vehicle; and sending, to the third base station onboard the third vehicle, a network connection resume message comprising the identifier associated with the apparatus context.

The apparatus may comprise means for: detecting a failure to receive, from the second base station onboard the second vehicle, a network connection setup complete message; determining that a third base station onboard a third vehicle is expected to be connected to the network; and sending, to the third base station onboard the third vehicle, a network connection setup message not comprising the identifier associated with the apparatus context.

Determining that the apparatus context stored on the first base station onboard the first vehicle is expected to be available to the second base station onboard the second vehicle may comprise: determining that an apparatus context transfer time has expired from time the connection with the network is suspended.

The apparatus context transfer time may be received by the apparatus from the first base station onboard the first satellite or may be calculated by the apparatus.

Determining that the apparatus context stored on the first base station onboard the first vehicle is expected to be available to the second base station onboard the second vehicle may comprise: receiving, from the first base station onboard the first vehicle, an indication of the second base station onboard the second vehicle or an indication of a cell served by the second base station onboard the second vehicle.

The indication may indicate that the apparatus context stored on the first base station onboard the first vehicle is expected to be available to the second base station onboard the second vehicle.

The network connection release message may comprise at least one: the apparatus context transfer time; the indication of the second base station onboard the second vehicle; or the indication of the cell served by the second base station onboard the second vehicle.

Determining that the apparatus context stored on the first base station onboard the first vehicle is expected to be available to the second base station onboard the second vehicle may comprise: receiving, from the second base station onboard the second vehicle, a paging message.

The paging message may comprise at least one of: an indication that the apparatus context is available to the second base station onboard the second vehicle; or an indication that the second base station onboard the second vehicle expects the apparatus to resume the network connection via the second base station onboard the second vehicle.

The apparatus may comprise means for: determining that the apparatus is moving out of coverage of the first base station onboard the first vehicle, or vice versa; and sending, to the first base station onboard the first vehicle or to the second base station onboard the second vehicle, an indication that the apparatus is moving out of coverage of the first base station onboard the first vehicle, or vice versa.

The apparatus may comprise means for: determining that the apparatus is moving in coverage of the second base station onboard the second vehicle, or vice versa.

The apparatus may comprise means for: determining that the apparatus has high priority data; attempting to set up the network connection via the second base station onboard the second vehicle without prior attempt to resume the network connection via the second base station onboard the second vehicle.

The apparatus may be a user equipment.

The first vehicle, the second vehicle and/or the third vehicle may be a satellite, a drone or a car.

The first vehicle, the second vehicle and/or the third vehicle may station may have intermittent connectivity with the network.

According to an aspect there is provided an apparatus comprising at least one processor and at least one memory including computer code for one or more programs, the at least one memory and the computer code configured, with the at least one processor, to cause the apparatus at least to: suspend a network connection via a first base station onboard a first vehicle; determine that an apparatus context stored on the first base station onboard the first vehicle is expected to be available to a second base station onboard a second vehicle; and attempt to resume the network connection via the second base station onboard the second vehicle.

The second base station onboard the second vehicle may or may not be connected to the network. Different scenarios may be contemplated when attempting to resume the network connection via the second base station onboard the second vehicle.

In a scenario, the second base station may be connected to the network and may not previously have received and stored the apparatus context from the first base station.

The second base station may now receive and store the apparatus context from the first base station. Thus, the apparatus context may be available to the second base station. Resuming the network connection via the second base station may be successful.

In another scenario, the second base station may be connected to the network and may previously have received and stored the apparatus context from the first base station. Thus, the apparatus context may be available to the second base station. Resuming the network connection via the second base station may be successful.

In another scenario, the second base station may not be connected to the network and may have previously be connected to the network. The second base station may have previously received and stored the apparatus context. Thus, the apparatus context may be available to the second base station. Resuming the network connection via the second base station may be successful.

In another scenario, the second base station may not be connected to the network and may or may not have previously be connected to the network. The second base station may not have previously received and stored the apparatus context. Thus, the apparatus context may not be available to the second base station Resuming the network connection via the second base station may not be successful.

The at least one memory and the computer code may be configured, with the at least one processor, to cause the apparatus at least to: receive, from the first base station onboard the first vehicle a network connection release message; and wherein attempting to resume the network connection via the second base station onboard the second vehicle may comprise: sending, to the second base station onboard the second vehicle; a network connection resume message.

The network connection release message may comprise an identifier associated with the apparatus context; and wherein the network connection resume message may comprise the identifier associated with the apparatus context.

The at least one memory and the computer code may be configured, with the at least one processor, to cause the apparatus at least to: receive, from the second base station onboard the second vehicle, a network connection resume complete message.

The at least one memory and the computer code may be configured, with the at least one processor, to cause the apparatus at least to: detect a failure to receive, from the second base station onboard the second vehicle, a network connection resume complete message; and store the identifier associated with the apparatus context on the apparatus.

The at least one memory and the computer code may be configured, with the at least one processor, to cause the apparatus at least to: subsequently re-send, to the second base station onboard the second vehicle; the network connection resume message comprising the identifier associated with the apparatus context.

The identifier may be stored with at least one of: a time parameter indicating how long the identifier is to be stored on the apparatus before deleting the identifier from the apparatus; a maximum number of tries parameter indicating a maximum number of times the apparatus is to subsequently re-send, to the second base station onboard the second vehicle; the network connection resume message comprising the identifier before deleting the identifier from the apparatus; or a maximum number of identifiers parameter indicating a maximum number of identifiers the apparatus is to store.

The at least one memory and the computer code may be configured, with the at least one processor, to cause the apparatus at least to: send, to the second base station onboard the second vehicle, a network connection setup message not comprising the identifier associated with the apparatus context.

The at least one memory and the computer code may be configured, with the at least one processor, to cause the apparatus at least to: detect a failure to receive, from the second base station onboard the second vehicle, a network connection setup complete message when the second base station onboard the second vehicle is not connected to the network.

The at least one memory and the computer code may be configured, with the at least one processor, to cause the apparatus at least to: detect a failure to receive, from the second base station onboard the second vehicle, a network connection setup complete message; determine that the apparatus context stored on the first base station onboard the first vehicle is expected to be available to a third base station onboard a third vehicle; and send, to the third base station onboard the third vehicle, a network connection resume message comprising the identifier associated with the apparatus context.

The at least one memory and the computer code may be configured, with the at least one processor, to cause the apparatus at least to: detect a failure to receive, from the second base station onboard the second vehicle, a network connection setup complete message; determine that a third base station onboard a third vehicle is expected to be connected to the network; and send, to the third base station onboard the third vehicle, a network connection setup message not comprising the identifier associated with the apparatus context.

Determining that the apparatus context stored on the first base station onboard the first vehicle is expected to be available to the second base station onboard the second vehicle may comprise: determining that an apparatus context transfer time has expired from time the connection with the network is suspended.

The apparatus context transfer time may be received by the apparatus from the first base station onboard the first satellite or may be calculated by the apparatus.

Determining that the apparatus context stored on the first base station onboard the first vehicle is expected to be available to the second base station onboard the second vehicle may comprise: receiving, from the first base station onboard the first vehicle, an indication of the second base station onboard the second vehicle or an indication of a cell served by the second base station onboard the second vehicle.

The indication may indicate that the apparatus context stored on the first base station onboard the first vehicle is expected to be available to the second base station onboard the second vehicle.

The network connection release message may comprise at least one: the apparatus context transfer time; the indication of the second base station onboard the second vehicle; or the indication of the cell served by the second base station onboard the second vehicle.

Determining that the apparatus context stored on the first base station onboard the first vehicle is expected to be available to the second base station onboard the second vehicle may comprise: receiving, from the second base station onboard the second vehicle, a paging message.

The paging message may comprise at least one of: an indication that the apparatus context is available to the second base station onboard the second vehicle; or an indication that the second base station onboard the second vehicle expects the apparatus to resume the network connection via the second base station onboard the second vehicle.

The at least one memory and the computer code may be configured, with the at least one processor, to cause the apparatus at least to: determine that the apparatus is moving out of coverage of the first base station onboard the first vehicle, or vice versa; and send, to the first base station onboard the first vehicle or to the second base station onboard the second vehicle, an indication that the apparatus is moving out of coverage of the first base station onboard the first vehicle, or vice versa.

The at least one memory and the computer code may be configured, with the at least one processor, to cause the apparatus at least to: determine that the apparatus is moving in coverage of the second base station onboard the second vehicle, or vice versa.

The at least one memory and the computer code may be configured, with the at least one processor, to cause the apparatus at least to: determine that the apparatus has high priority data; attempt to set up the network connection via the second base station onboard the second vehicle without prior attempt to resume the network connection via the second base station onboard the second vehicle.

The apparatus may be a user equipment.

The first vehicle, the second vehicle and/or the third vehicle may be a satellite, a drone or a car.

The first vehicle, the second vehicle and/or the third vehicle may station may have intermittent connectivity with the network.

According to an aspect there is provided an apparatus comprising circuitry configured to: suspend a network connection via a first base station onboard a first vehicle;

determine that an apparatus context stored on the first base station onboard the first vehicle is expected to be available to a second base station onboard a second vehicle;

and attempt to resume the network connection via the second base station onboard the second vehicle.

The second base station onboard the second vehicle may or may not be connected to the network. Different scenarios may be contemplated when attempting to resume the network connection via the second base station onboard the second vehicle.

In a scenario, the second base station may be connected to the network and may not previously have received and stored the apparatus context from the first base station. The second base station may now receive and store the apparatus context from the first base station. Thus, the apparatus context may be available to the second base station. Resuming the network connection via the second base station may be successful.

In another scenario, the second base station may be connected to the network and may previously have received and stored the apparatus context from the first base station. Thus, the apparatus context may be available to the second base station. Resuming the network connection via the second base station may be successful.

In another scenario, the second base station may not be connected to the network and may have previously be connected to the network. The second base station may have previously received and stored the apparatus context. Thus, the apparatus context may be available to the second base station. Resuming the network connection via the second base station may be successful.

In another scenario, the second base station may not be connected to the network and may or may not have previously be connected to the network. The second base station may not have previously received and stored the apparatus context. Thus, the apparatus context may not be available to the second base station Resuming the network connection via the second base station may not be successful.

The apparatus may comprise circuitry configured to: receive, from the first base station onboard the first vehicle a network connection release message; and wherein attempting to resume the network connection via the second base station onboard the second vehicle may comprise: sending, to the second base station onboard the second vehicle; a network connection resume message.

The network connection release message may comprise an identifier associated with the apparatus context; and wherein the network connection resume message may comprise the identifier associated with the apparatus context.

The apparatus may comprise circuitry configured to: receive, from the second base station onboard the second vehicle, a network connection resume complete message.

The apparatus may comprise circuitry configured to: detect a failure to receive, from the second base station onboard the second vehicle, a network connection resume complete message; and store the identifier associated with the apparatus context on the apparatus.

The apparatus may comprise circuitry configured to: subsequently re-send, to the second base station onboard the second vehicle; the network connection resume message comprising the identifier associated with the apparatus context.

The identifier may be stored with at least one of: a time parameter indicating how long the identifier is to be stored on the apparatus before deleting the identifier from the apparatus; a maximum number of tries parameter indicating a maximum number of times the apparatus is to subsequently re-send, to the second base station onboard the second vehicle; the network connection resume message comprising the identifier before deleting the identifier from the apparatus; or a maximum number of identifiers parameter indicating a maximum number of identifiers the apparatus is to store.

The apparatus may comprise circuitry configured to: send, to the second base station onboard the second vehicle, a network connection setup message not comprising the identifier associated with the apparatus context.

The apparatus may comprise circuitry configured to: detect a failure to receive, from the second base station onboard the second vehicle, a network connection setup complete message when the second base station onboard the second vehicle is not connected to the network.

The apparatus may comprise circuitry configured to: detect a failure to receive, from the second base station onboard the second vehicle, a network connection setup complete message; determine that the apparatus context stored on the first base station onboard the first vehicle is expected to be available to a third base station onboard a third vehicle; and send, to the third base station onboard the third vehicle, a network connection resume message comprising the identifier associated with the apparatus context.

The apparatus may comprise circuitry configured to: detect a failure to receive, from the second base station onboard the second vehicle, a network connection setup complete message; determine that a third base station onboard a third vehicle is expected to be connected to the network; and send, to the third base station onboard the third vehicle, a network connection setup message not comprising the identifier associated with the apparatus context.

Determining that the apparatus context stored on the first base station onboard the first vehicle is expected to be available to the second base station onboard the second vehicle may comprise: determining that an apparatus context transfer time has expired from time the connection with the network is suspended.

The apparatus context transfer time may be received by the apparatus from the first base station onboard the first satellite or may be calculated by the apparatus.

Determining that the apparatus context stored on the first base station onboard the first vehicle is expected to be available to the second base station onboard the second vehicle may comprise: receiving, from the first base station onboard the first vehicle, an indication of the second base station onboard the second vehicle or an indication of a cell served by the second base station onboard the second vehicle.

The indication may indicate that the apparatus context stored on the first base station onboard the first vehicle is expected to be available to the second base station onboard the second vehicle.

The network connection release message may comprise at least one: the apparatus context transfer time; the indication of the second base station onboard the second vehicle; or the indication of the cell served by the second base station onboard the second vehicle.

Determining that the apparatus context stored on the first base station onboard the first vehicle is expected to be available to the second base station onboard the second vehicle may comprise: receiving, from the second base station onboard the second vehicle, a paging message.

The paging message may comprise at least one of: an indication that the apparatus context is available to the second base station onboard the second vehicle; or an indication that the second base station onboard the second vehicle expects the apparatus to resume the network connection via the second base station onboard the second vehicle.

The apparatus may comprise circuitry configured to: determine that the apparatus is moving out of coverage of the first base station onboard the first vehicle, or vice versa; and send, to the first base station onboard the first vehicle or to the second base station onboard the second vehicle, an indication that the apparatus is moving out of coverage of the first base station onboard the first vehicle, or vice versa.

The apparatus may comprise circuitry configured to: determine that the apparatus is moving in coverage of the second base station onboard the second vehicle, or vice versa.

The apparatus may comprise circuitry configured to: determine that the apparatus has high priority data; attempt to set up the network connection via the second base station onboard the second vehicle without prior attempt to resume the network connection via the second base station onboard the second vehicle.

The apparatus may be a user equipment.

The first vehicle, the second vehicle and/or the third vehicle may be a satellite, a drone or a car.

The first vehicle, the second vehicle and/or the third vehicle may station may have intermittent connectivity with the network.

According to an aspect there is provided a method comprising: suspending a network connection via a first base station onboard a first vehicle; determining that an apparatus context stored on the first base station onboard the first vehicle is expected to be available to a second base station onboard a second vehicle; and attempting to resume the network connection via the second base station onboard the second vehicle.

The method may be performed by the apparatus.

The second base station onboard the second vehicle may or may not be connected to the network. Different scenarios may be contemplated when attempting to resume the network connection via the second base station onboard the second vehicle.

In a scenario, the second base station may be connected to the network and may not previously have received and stored the apparatus context from the first base station. The second base station may now receive and store the apparatus context from the first base station. Thus, the apparatus context may be available to the second base station. Resuming the network connection via the second base station may be successful.

In another scenario, the second base station may be connected to the network and may previously have received and stored the apparatus context from the first base station. Thus, the apparatus context may be available to the second base station. Resuming the network connection via the second base station may be successful.

In another scenario, the second base station may not be connected to the network and may have previously be connected to the network. The second base station may have previously received and stored the apparatus context. Thus, the apparatus context may be available to the second base station. Resuming the network connection via the second base station may be successful.

In another scenario, the second base station may not be connected to the network and may or may not have previously be connected to the network. The second base station may not have previously received and stored the apparatus context. Thus, the apparatus context may not be available to the second base station Resuming the network connection via the second base station may not be successful.

The method may comprise: receiving, from the first base station onboard the first vehicle a network connection release message; and wherein attempting to resume the network connection via the second base station onboard the second vehicle may comprise: sending, to the second base station onboard the second vehicle; a network connection resume message.

The network connection release message may comprise an identifier associated with the apparatus context; and wherein the network connection resume message may comprise the identifier associated with the apparatus context.

The method may comprise: receiving, from the second base station onboard the second vehicle, a network connection resume complete message.

The method may comprise: detecting a failure to receive, from the second base station onboard the second vehicle, a network connection resume complete message; and storing the identifier associated with the apparatus context on the apparatus.

The method may comprise: subsequently re-sending, to the second base station onboard the second vehicle; the network connection resume message comprising the identifier associated with the apparatus context.

The identifier may be stored with at least one of: a time parameter indicating how long the identifier is to be stored on the apparatus before deleting the identifier from the apparatus; a maximum number of tries parameter indicating a maximum number of times the apparatus is to subsequently re-send, to the second base station onboard the second vehicle; the network connection resume message comprising the identifier before deleting the identifier from the apparatus; or a maximum number of identifiers parameter indicating a maximum number of identifiers the apparatus is to store.

The method may comprise: sending, to the second base station onboard the second vehicle, a network connection setup message not comprising the identifier associated with the apparatus context.

The method may comprise: detecting a failure to receive, from the second base station onboard the second vehicle, a network connection setup complete message when the second base station onboard the second vehicle is not connected to the network.

The method may comprise: detecting a failure to receive, from the second base station onboard the second vehicle, a network connection setup complete message;

determining that the apparatus context stored on the first base station onboard the first vehicle is expected to be available to a third base station onboard a third vehicle; and

sending, to the third base station onboard the third vehicle, a network connection resume message comprising the identifier associated with the apparatus context.

The method may comprise: detecting a failure to receive, from the second base station onboard the second vehicle, a network connection setup complete message; determining that a third base station onboard a third vehicle is expected to be connected to the network; and sending, to the third base station onboard the third vehicle, a network connection setup message not comprising the identifier associated with the apparatus context.

Determining that the apparatus context stored on the first base station onboard the first vehicle is expected to be available to the second base station onboard the second vehicle may comprise: determining that an apparatus context transfer time has expired from time the connection with the network is suspended.

The apparatus context transfer time may be received by the apparatus from the first base station onboard the first satellite or may be calculated by the apparatus.

Determining that the apparatus context stored on the first base station onboard the first vehicle is expected to be available to the second base station onboard the second vehicle may comprise: receiving, from the first base station onboard the first vehicle, an indication of the second base station onboard the second vehicle or an indication of a cell served by the second base station onboard the second vehicle.

The indication may indicate that the apparatus context stored on the first base station onboard the first vehicle is expected to be available to the second base station onboard the second vehicle.

The network connection release message may comprise at least one: the apparatus context transfer time; the indication of the second base station onboard the second vehicle; or the indication of the cell served by the second base station onboard the second vehicle.

Determining that the apparatus context stored on the first base station onboard the first vehicle is expected to be available to the second base station onboard the second vehicle may comprise: receiving, from the second base station onboard the second vehicle, a paging message.

The paging message may comprise at least one of: an indication that the apparatus context is available to the second base station onboard the second vehicle; or an apparatus to resume the network connection via the second base station onboard the second vehicle.

The method may comprise: determining that the apparatus is moving out of coverage of the first base station onboard the first vehicle, or vice versa; and sending, to the first base station onboard the first vehicle or to the second base station onboard the second vehicle, an indication that the apparatus is moving out of coverage of the first base station onboard the first vehicle, or vice versa.

The method may comprise: determining that the apparatus is moving in coverage of the second base station onboard the second vehicle, or vice versa.

The method may comprise: determining that the apparatus has high priority data; attempting to set up the network connection via the second base station onboard the second vehicle without prior attempt to resume the network connection via the second base station onboard the second vehicle.

The apparatus may be a user equipment.

The first vehicle, the second vehicle and/or the third vehicle may be a satellite, a drone or a car.

The first vehicle, the second vehicle and/or the third vehicle may station may have intermittent connectivity with the network.

According to an aspect there is provided a computer program comprising computer executable code which when run on at least one processor is configured to: suspend a network connection via a first base station onboard a first vehicle; determine that an apparatus context stored on the first base station onboard the first vehicle is expected to be available to a second base station onboard a second vehicle; and attempt to resume the network connection via the second base station onboard the second vehicle.

The at least one processor may be part of the apparatus.

The second base station onboard the second vehicle may or may not be connected to the network. Different scenarios may be contemplated when attempting to resume the network connection via the second base station onboard the second vehicle.

In a scenario, the second base station may be connected to the network and may not previously have received and stored the apparatus context from the first base station. The second base station may now receive and store the apparatus context from the first base station. Thus, the apparatus context may be available to the second base station. Resuming the network connection via the second base station may be successful.

In another scenario, the second base station may be connected to the network and may previously have received and stored the apparatus context from the first base station. Thus, the apparatus context may be available to the second base station. Resuming the network connection via the second base station may be successful.

In another scenario, the second base station may not be connected to the network and may have previously be connected to the network. The second base station may have previously received and stored the apparatus context. Thus, the apparatus context may be available to the second base station. Resuming the network connection via the second base station may be successful.

In another scenario, the second base station may not be connected to the network and may or may not have previously be connected to the network. The second base station may not have previously received and stored the apparatus context. Thus, the apparatus context may not be available to the second base station Resuming the network connection via the second base station may not be successful.

The computer program may comprise computer executable code which when run on at least one processor is configured to: receive, from the first base station onboard the first vehicle a network connection release message; and wherein attempting to resume the network connection via the second base station onboard the second vehicle may comprise: sending, to the second base station onboard the second vehicle; a network connection resume message.

The network connection release message may comprise an identifier associated with the apparatus context; and wherein the network connection resume message may comprise the identifier associated with the apparatus context.

The computer program may comprise computer executable code which when run on at least one processor is configured to: receive, from the second base station onboard the second vehicle, a network connection resume complete message.

The computer program may comprise computer executable code which when run on at least one processor is configured to: detect a failure to receive, from the second base station onboard the second vehicle, a network connection resume complete message; and store the identifier associated with the apparatus context on the apparatus.

The computer program may comprise computer executable code which when run on at least one processor is configured to: subsequently re-send, to the second base station onboard the second vehicle; the network connection resume message comprising the identifier associated with the apparatus context.

The identifier may be stored with at least one of: a time parameter indicating how long the identifier is to be stored on the apparatus before deleting the identifier from the apparatus; a maximum number of tries parameter indicating a maximum number of times the apparatus is to subsequently re-send, to the second base station onboard the second vehicle; the network connection resume message comprising the identifier before deleting the identifier from the apparatus; or a maximum number of identifiers parameter indicating a maximum number of identifiers the apparatus is to store.

The computer program may comprise computer executable code which when run on at least one processor is configured to: send, to the second base station onboard the second vehicle, a network connection setup message not comprising the identifier associated with the apparatus context.

The computer program may comprise computer executable code which when run on at least one processor is configured to: detect a failure to receive, from the second base station onboard the second vehicle, a network connection setup complete message when the second base station onboard the second vehicle is not connected to the network.

The computer program may comprise computer executable code which when run on at least one processor is configured to: detect a failure to receive, from the second base station onboard the second vehicle, a network connection setup complete message; determine that the apparatus context stored on the first base station onboard the first vehicle is expected to be available to a third base station onboard a third vehicle; and send, to the third base station onboard the third vehicle, a network connection resume message comprising the identifier associated with the apparatus context.

The computer program may comprise computer executable code which when run on at least one processor is configured to: detect a failure to receive, from the second base station onboard the second vehicle, a network connection setup complete message; determine that a third base station onboard a third vehicle is expected to be connected to the network; and send, to the third base station onboard the third vehicle, a network connection setup message not comprising the identifier associated with the apparatus context.

Determining that the apparatus context stored on the first base station onboard the first vehicle is expected to be available to the second base station onboard the second vehicle may comprise: determining that an apparatus context transfer time has expired from time the connection with the network is suspended.

The apparatus context transfer time may be received by the apparatus from the first base station onboard the first satellite or may be calculated by the apparatus.

Determining that the apparatus context stored on the first base station onboard the first vehicle is expected to be available to the second base station onboard the second vehicle may comprise: receiving, from the first base station onboard the first vehicle, an indication of the second base station onboard the second vehicle or an indication of a cell served by the second base station onboard the second vehicle.

The indication may indicate that the apparatus context stored on the first base station onboard the first vehicle is expected to be available to the second base station onboard the second vehicle.

The network connection release message may comprise at least one: the apparatus context transfer time; the indication of the second base station onboard the second vehicle; or the indication of the cell served by the second base station onboard the second vehicle.

Determining that the apparatus context stored on the first base station onboard the first vehicle is expected to be available to the second base station onboard the second vehicle may comprise: receiving, from the second base station onboard the second vehicle, a paging message.

The paging message may comprise at least one of: an indication that the apparatus context is available to the second base station onboard the second vehicle; or an apparatus to resume the network connection via the second base station onboard the second vehicle.

The computer program may comprise computer executable code which when run on at least one processor is configured to: determine that the apparatus is moving out of coverage of the first base station onboard the first vehicle, or vice versa; and send, to the first base station onboard the first vehicle or to the second base station onboard the second vehicle, an indication that the apparatus is moving out of coverage of the first base station onboard the first vehicle, or vice versa.

The computer program may comprise computer executable code which when run on at least one processor is configured to: determine that the apparatus is moving in coverage of the second base station onboard the second vehicle, or vice versa.

The computer program may comprise computer executable code which when run on at least one processor is configured to: determine that the apparatus has high priority data; attempt to set up the network connection via the second base station onboard the second vehicle without prior attempt to resume the network connection via the second base station onboard the second vehicle.

The apparatus may be a user equipment.

The first vehicle, the second vehicle and/or the third vehicle may be a satellite, a drone or a car.

The first vehicle, the second vehicle and/or the third vehicle may station may have intermittent connectivity with the network.

According to an aspect, there is provided a computer readable medium comprising program instructions stored thereon for performing at least one of the above methods.

According to an aspect, there is provided a non-transitory computer readable medium comprising program instructions stored thereon for performing at least one of the above methods.

According to an aspect, there is provided a non-volatile tangible memory medium comprising program instructions stored thereon for performing at least one of the above methods.

In the above, many different aspects have been described. It should be appreciated that further aspects may be provided by the combination of any two or more of the aspects described above.

Various other aspects are also described in the following detailed description and in the attached claims.

### List of Abbreviations

AF: Application Function
AMF: Access and Mobility Management Function
API: Application Programming Interface
AS: Access Stratum
BS: Base Station
CU: Centralized Unit
CP: Control Plane
DL: Downlink
DU: Distributed Unit
EPS: Evolved packet System
eMTC: enhanced Machine Type Communication
eNB: eNodeB or eNode B or E-UTRAN node B
gNB: gNode B
GSM: Global System for Mobile communication
GW: Gateway
HSS: Home Subscriber Server
ID: Identifier
IoT: Internet of Things
LTE: Long Term Evolution
MAC: Medium Access Control
MS: Mobile Station
MTC: Machine Type Communication
NAS: Non-Access Stratum
NEF: Network Exposure Function
NF: Network Function
NR: New radio
NRF: Network Repository Function
NTN: Non-Terrestrial Network
PDU: Packet Data Unit
RAM: Random Access Memory
(R)AN: (Radio) Access Network
ROM: Read Only Memory
RRC: Radio Resource Control
S&F: Store & Forward
SMF: Session Management Function
TAU: Tracking Area Update
TN: Terrestrial Network
TR: Technical Report
TS: Technical Specification
UE: User Equipment
UMTS: Universal Mobile Telecommunication System
UP: User Plane
WI: Work Item
3GPP: 3^{rd} Generation Partnership Project
5G: 5^{th} Generation
5GC: 5G Core network
5GS: 5G System

### BRIEF DESCRIPTION OF THE FIGURES

Embodiments will now be described, by way of example only, with reference to the accompanying Figures in which:

FIG. 1 shows a schematic representation of a 5G system;

FIG. 2 shows a schematic representation of a control apparatus;

FIG. 3 shows a schematic representation of a user equipment;

FIG. 4 shows a signaling diagram of a radio resource control connection resume procedure in an evolved packet system as per TS 36.330 (FIG. 7.3a.3-3: RRC Connection Resume procedure in different eNB in EPS);

FIG. 5 shows a deployment wherein a first eNode B onboard a first satellite is connected to a network, a second eNode B onboard a second satellite is not connected to the network and a third eNode B onboard a third satellite is connected to the network;

FIG. 6 is a flow chart of a method for attempting to resume a network connection via a base station onboard a vehicle;

FIG. 7 shows a block diagram of a method for attempting to resume a network connection via a base station onboard a vehicle; and

FIG. 8 shows a schematic representation of a non-volatile memory medium storing instructions which when executed by a processor allow a processor to perform one or more of the steps of the methods of FIG. 7.

### DETAILED DESCRIPTION OF THE FIGURES

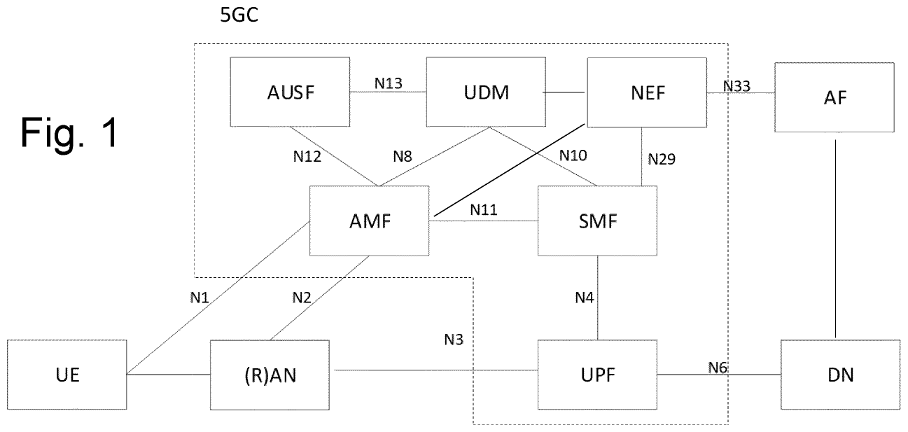

In the following certain embodiments are explained with reference to mobile communication devices capable of communication via a wireless cellular system and mobile communication systems serving such mobile communication devices. Before explaining in detail the exemplifying embodiments, certain general principles of a wireless communication system, access systems thereof, and mobile communication devices are briefly explained with reference to FIGS. 1, 2 and 3 to assist in understanding the technology underlying the described examples.

FIG. 1 shows a schematic representation of a 5G system (5GS). The 5GS may comprises a user equipment (UE), a (radio) access network ((R)AN), a 5G core network (5GC), one or more application functions (AF) and one or more data networks (DN).

The 5G (R)AN may comprise a terrestrial network (TN) part wherein one or more gNB are located on one or more masts or towers on the ground. The 5G (R)AN may comprise a non-terrestrial network (NTN) part wherein one or more gNB are located on one or more satellites or on one or more masts or towers on the ground.

The one or more gNB may comprise one or more gNB distributed unit functions connected to one or more gNB centralized unit functions.

The 5GC may comprise an access and mobility management function (AMF), a session management function (SMF), an authentication server function (AUSF), a user data management (UDM), a user plane function (UPF) and/or a network exposure function (NEF). The 5GC may comprise a gateway (GW) to the NTN part of the 5G (R)AN.

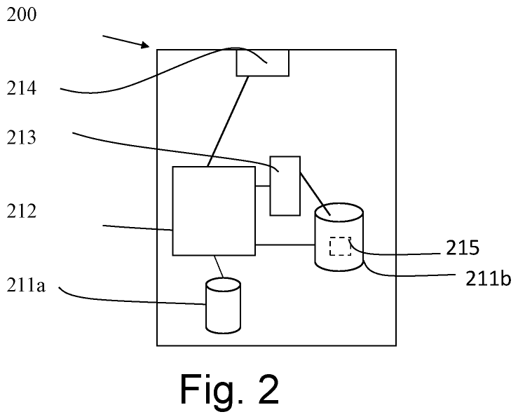

FIG. 2 illustrates an example of a control apparatus 200 for controlling a function of the (R)AN or the 5GC as illustrated on FIG. 1. The control apparatus may comprise at least one random access memory (RAM) 211a, at least on read only memory (ROM) 211b, at least one processor 212, 213 and an input/output interface 214. The at least one processor 212, 213 may be coupled to the RAM 211a and the ROM 211b. The at least one processor 212, 213 may be configured to execute an appropriate software code 215. The software code 215 may for example allow to perform one or more steps to perform one or more of the present aspects. The software code 215 may be stored in the ROM 211b. The control apparatus 200 may be interconnected with another control apparatus 200 controlling another function of the 5G (R)AN or the 5GC. In some embodiments, each function of the (R)AN or the 5GC comprises a control apparatus 200. In alternative embodiments, two or more functions of the (R)AN or the 5GC may share a control apparatus.

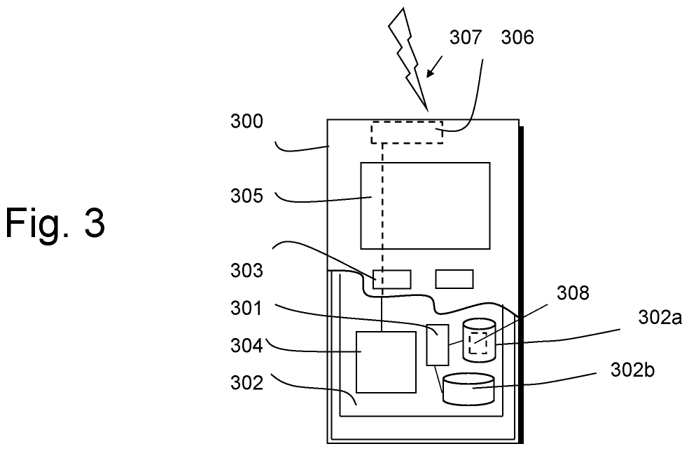

FIG. 3 illustrates an example of a user equipment 300, such as the user equipment (UE) illustrated on FIG. 1. The UE 300 may be provided by any device capable of sending and receiving radio signals. Non-limiting examples comprise a user equipment, a mobile station (MS) or mobile device such as a mobile phone or what is known as a ‘smart phone’, a computer provided with a wireless interface card or other wireless interface facility (e.g., USB dongle), a personal data assistant (PDA) or a tablet provided with wireless communication capabilities, a machine-type communications (MTC) device, a Cellular Internet of things (CIoT) UE or any combinations of these or the like. The UE 300 may provide, for example, communication of data for carrying communications. The communications may be one or more of voice, electronic mail (email), text message, multimedia, data, machine data and so on.

The UE 300 may receive signals over an air or radio interface 307 via appropriate apparatus for receiving and may transmit signals via appropriate apparatus for transmitting radio signals. In FIG. 3 transceiver apparatus is designated schematically by block 306. The transceiver apparatus 306 may be provided for example by means of a radio part and associated antenna arrangement. The antenna arrangement may be arranged internally or externally to the mobile device.

The UE 300 may be provided with at least one processor 301, at least one memory ROM 302a, at least one RAM 302b and other possible components 303 for use in software and hardware aided execution of tasks it is designed to perform, including control of access to and communications with access systems and other communication devices. The at least one processor 301 is coupled to the RAM 302b and the ROM 302a. The at least one processor 301 may be configured to execute an appropriate software code 308. The software code 308 may for example allow to perform one or more of the present aspects. The software code 308 may be stored in the ROM 302a.

The processor, storage and other relevant control apparatus can be provided on an appropriate circuit board and/or in chipsets. This feature is denoted by reference 304. The device may optionally have a user interface such as keypad 305, touch sensitive screen or pad, combinations thereof or the like. Optionally one or more of a display, a speaker and a microphone may be provided depending on the type of the device.

One or more aspects of this disclosure relate to NTNs. NTN have been defined for NR and Narrow Band Internet of Things (NB-IoT) and/or enhance machine type communication (eMTC) in release 17. As part of preparations for release 18, companies submitted proposals for work item descriptions at RAN #94e in December 2021.

In RP-212940 satellite companies submitted a joint proposal including included a new scenario: store and forward operation for IoT NTN. RP-212940 (section 4.1.4 Support for store-and-forward operation) reads as follows.

“Store-and-forward (S&F) is a new feature that will allow a satellite to provide service to IoT NTN devices even in periods/areas when/where the satellite is not connected to a Gateway on the ground. An eNB on board architecture is assumed. Non simultaneous operation of the service link and the feeder link is assumed. Messages are stored on board until there is line of sight with the GW. The following candidate set of enhancements objectives are listed:
Support of decoupled signalling procedures “UE<->Satellite with onboard RAN node” and “Satellite with onboard RAN node <->CN on the ground” for achieving end-to-end functionality. [RAN2, RAN3]
Dynamic attachment between S-GW and eNB [RAN3]”

Store and forward operation builds on the release 17 concept of discontinuous coverage scenario, where a UE only occasionally and temporarily has coverage from a satellite. The discontinuous coverage scenario may be expanded by also defining that the satellite is not always connected with the core network (i.e. GW).

The description below applies to EPS as an example but it will be understood that it may be applicable to other systems, such as 5GS or subsequent generation systems. The description relates to eNBs as an example but it will be understood that it may be applicable to other BSs, such as gNBs or subsequent generation BSs.

Store and forward operation may enable a low-cost deployment consisting of just a few BSs onboard satellites and a few BSs on the ground. This means that the connectivity cost per UE may be reduced at the cost of only being able to support delay tolerant data.

A challenge in store and forward operation scenario is how a UE can establish a RRC connection (i.e. secure connection) with the EPC, when the link between UE and eNB onboard a satellite and the link between the eNB onboard the satellite and the EPC are not available simultaneously.

Assuming a RRC connection has been established by the UE with the EPC, it may be beneficial to retain a UE context at the UE and the eNB onboard the satellite. The UE context may comprise access stratum (AS) and radio resource control (RRC) configuration.

The UE may receive a RRC connection release message from the eNB onboard the satellite. The RRC connection release message may comprise an indication (e.g. cause) indicating that the RRC connection is suspended. The RRC connection release message may comprise a resume ID.

The resume ID may be associated with the UE context. The resume ID may be stored by the eNB onboard the satellite along with the UE context. The resume ID may comprise a UE ID part and/or an eNB ID part. The resume ID may comprise an inactive radio network temporary identifier in 5GS.

The UE may subsequently decide to resume the RRC connection. For example, the UE may wish to resume the RRC connection when the UE has UE originated traffic to transmit to the EPC. The UE may wish to resume the RRC connection after a radio link failure. The UE may wish to resume RRC connection after a handover failure. The

UE may wish to resume RRC connection after receiving a paging message from the EPC.

When the UE wishes to resume the RRC connection, the UE may send a RRC connection resume message to another eNB onboard another satellite. The RRC connection resume message may comprise the resume ID. The resume ID may allow the other eNB onboard the other satellite to fetch the UE context from the eNB onboard the satellite via the EPC and store the UE context on the other eNB onboard the other satellite.

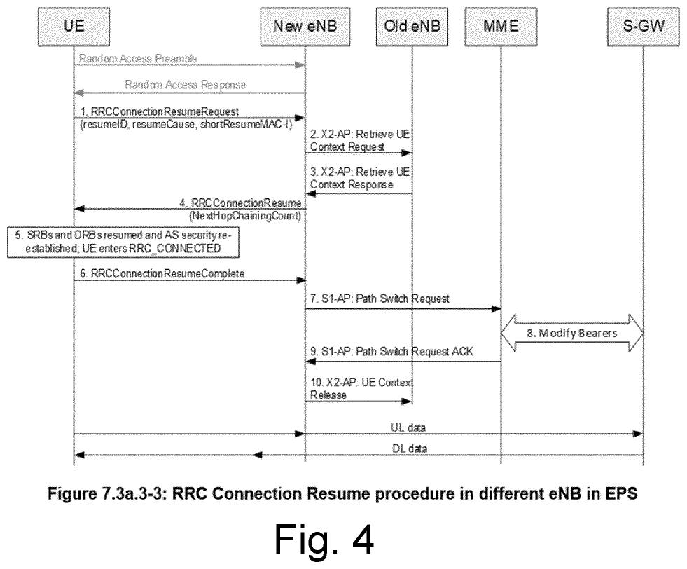

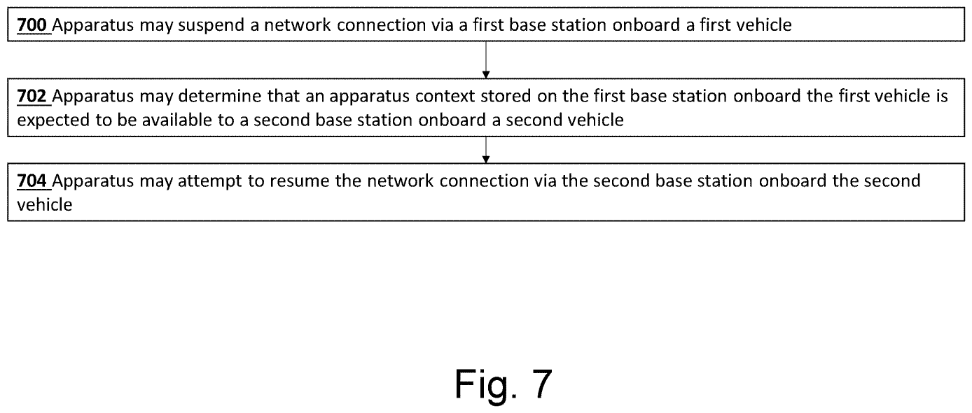

FIG. 4 shows a signaling diagram of a radio resource control connection resume procedure in an evolved packet system as per TS 36.330 (FIG. 7.3a.3-3: RRC Connection Resume procedure in different eNB in EPS). TS 36.330 (section 7.3a.3-3 User Plane CIoT EPS/5GS optimisations) reads as follows.
“1. Same as step 1 in the intra (ng-)eNB connection resumption.
2. The new (ng-)eNB locates the old (ng-)eNB using the Resume ID (for EPS) or I-RNTI (for 5GS) and retrieves the UE context by means of the X2-AP (for EPS) or Xn-AP (for 5GS) Retrieve UE Context procedure.
3. The old (ng-)eNB responds with the UE context associated with the Resume ID (for EPS) or I-RNTI (for 5GS).
4. Same as step 2 in the intra (ng-)eNB connection resumption.
5. Same as step 3 in the intra (ng-)eNB connection resumption.
6. Same as step 4 in the intra (ng-)eNB connection resumption.
7. For EPS, the new eNB initiates the S1-AP Path Switch procedure to establish a S1 UE associated signalling connection to the serving MME and to request the MME to resume the UE context. For 5GS, the new ng-eNB initiates the NG-AP Path Switch procedure to establish a NG UE associated signalling connection to the serving AMF and to request the AMF to resume the UE context.
8. For EPS, the MME requests the S-GW to activate the S1-U bearers for the UE and updates the downlink path. For 5GS, the AMF requests the SMF to resume the PDU session and the SMF requests the UPF to create the tunnel information for the UE and update the downlink path.
9. MME/AMF Acks step 7.
10. For EPS, after the S1-AP Path Switch procedure the new eNB triggers release of the UE context at the old eNB by means of the X2-AP UE Context Release procedure. For 5GS, after the NG-AP Path Switch procedure the new ng-eNB triggers release of the UE context at the old ng-eNB by means of the Xn-AP UE Context Release procedure”.

As illustrated in FIG. 4, the other eNB onboard the other satellite (i.e. the “new eNB”) is may be expected to retrieve the UE context from the eNB onboard the satellite (i.e. the “old eNB”) via the EPC. This may be challenging in store and forward operation because the other eNB onboard the other satellite (i.e. the “new eNB”) and the eNB onboard the satellite (i.e. the “old eNB”) may not be connected to the EPC simultaneously.

One or more aspects of this disclosure may provide options for how to configure a UE to attempt to resume an RRC Connection via the other base station onboard the other satellite (i.e. the “new eNB”), in particular in store and forward operation.

TS 36.331 (section 5.3.3.2 Initiation) defines condition for resuming an RRC connection and reads as follows.

“The UE initiates the procedure when upper layers request establishment or resume of an RRC connection while the UE is in RRC_IDLE or when upper layers request resume of an RRC connection or RRC layer requests resume of an RRC connection for, e.g. RNAU or reception of RAN paging while the UE is in RRC_INACTIVE”.

The UE may initiate a RRC connection procedure by sending a RRC connection resume request message the other eNB onboard the other satellite. The RRC connection resume request message may comprise information as follows.

RRCConnectionResumeRequest message

-- ASN1START

| | |
|---|---|
| RRCConnectionResumeRequest-r13 ::= | SEQUENCE { |
| criticalExtensions | CHOICE { |
| rrcConnectionResumeRequest-r13 | RRCConnectionResumeRequest- |

r13-IEs,

| | |
|---|---|
| rrcConnectionResumeRequest-r15 | RRCConnectionResumeRequest- |

5GC-r15-IEs
}
}

| | |
|---|---|
| RRCConnectionResumeRequest-r13-IEs ::= | SEQUENCE { |
| resumeIdentity-r13 | CHOICE { |
| resumeID-r13 | ResumeIdentity-r13, |
| truncatedResumeID-r13 | BIT STRING (SIZE (24)) |

},

| | |
|---|---|
| shortResumeMAC-I-r13 | BIT STRING (SIZE (16)), |
| resumeCause-r13 | ResumeCause, |
| spare | BIT STRING (SIZE (1)) |

}

| | |
|---|---|
| RRCConnectionResumeRequest-5GC-r15-IEs ::= | SEQUENCE { |
| resumeIdentity-r15 | CHOICE { |
| fullI-RNTI-r15 | I-RNTI-r15, |
| shortI-RNTI-r15 | ShortI-RNTI-r15 |

},

| | |
|---|---|
| shortResumeMAC-I-r15 | BIT STRING (SIZE (16)), |
| resumeCause-r15 | ResumeCause-r15, |
| spare | BIT STRING (SIZE (1)) |

}

| | |
|---|---|
| ResumeCause ::= | ENUMERATED { |
| | emergency, highPriorityAccess, mt-Access, mo- |

Signalling,

mo-Data, delayTolerantAccess-v1020, mo-VoiceCall-

v1280,

mt-EDT-v1610

}

| | |
|---|---|
| ResumeCause-r15 ::= | ENUMERATED { |
| | emergency, highPriorityAccess, mt-Access, mo- |

Signalling,

mo-Data, rna-Update, mo-VoiceCall, spare1

}
-- ASN1STOP

RRCConnectionResumeRequest field descriptions

resumeCause
Provides the resume cause for the RRC connection resume request as provided by the
upper layers. The network is not expected to reject a RRCConnectionResumeRequest
due to unknown cause value being used by the UE.
resumeIdentity
UE identity to facilitate UE context retrieval at eNB
shortResumeMAC-I
Authentication token to facilitate UE authentication at eNB

When sending the RRC connection resume message to the other eNB onboard the other satellite (i.e. the “new eNB”), the UE may restore the RRC configuration. The UE may apply integrity protection and ciphering according to existing security context.

In a scenario, the other eNB onboard the other satellite (i.e. the “new eNB”) may respond to the RRC connection resume message with another RRC connection resume message. The UE may update security keys based on content of the other RRC connection resume message and the UE context. The UE may continue to resume the RRC connection via the other eNB onboard the other satellite (i.e. the “new eNB”).

In another scenario, the other eNB onboard the other satellite (i.e. the “new eNB”) may respond to the RRC connection resume message with a RRC connection setup: message. The UE may discard the UE context (including security keys).

In another scenario, the other eNB onboard the other satellite (i.e. the “new eNB”) may respond to the RRC connection resume message with a RRC connection reject message. The UE may discard the UE context (including security keys). The UE may inform upper layers about the failure to resume the RRC connection via the other eNB onboard the other satellite.

In another scenario, the other eNB onboard the other satellite (i.e. the “new eNB”) may respond to the RRC connection resume message with a RRC connection release message. The UE may update the UE context (including security keys and C-RNTI). The UE may remain in suspended RRC state.

One or more aspects of this disclosure may configure how and/or when a UE is allowed to attempt to resume a RRC connection via the other eNB onboard the other satellite (i.e. the “new eNB”) in store and forward operation scenario.

In a scenario, it may be assumed that the UE context is likely to be available to the other eNB onboard the other satellite (i.e. the “new eNB”) before and/or when the UE is in the coverage of the other eNB onboard the other satellite (i.e. the “new eNB”).

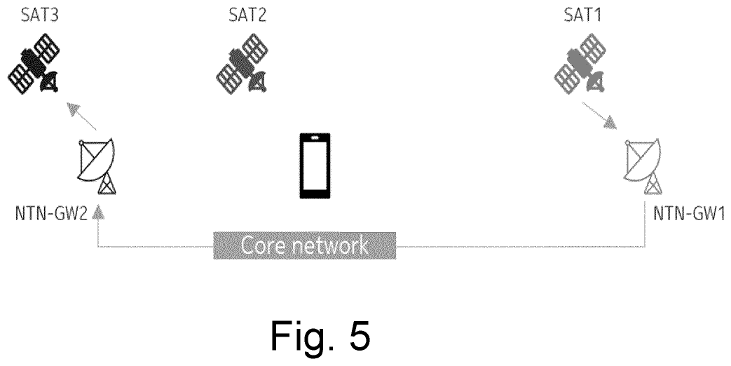

FIG. 5 shows a deployment wherein a first eNode B onboard a first satellite SAT1 is connected to the EPC, a second eNode B onboard a second satellite SAT2 is not connected to the EPC and a third eNode B onboard a third satellite SAT3 is connected to the EPC.

The UE may setup a RRC connection via the first eNode B onboard the first satellite SAT1. For example, the UE may send a RCC connection setup message to the first eNode B onboard the first satellite SAT1. The first eNode B onboard the first satellite SAT1 may store a resume ID associated with the UE context along the UE context.

The first eNode B onboard the first satellite SAT1 may instruct the UE to suspend the RRC connection. For example, the UE first eNode B onboard the first satellite SAT1 may send a RRC connection release message to the UE.

The RRC connection release message may comprise the resume ID associated with the UE context.

The RRC connection release message may comprise a UE context transfer time allowing the first eNode B onboard the first satellite SAT1, the EPC or a proxy to transfer the UE context to the third eNode B onboard the third satellite SAT3.

The RRC connection release message may comprise an indication of the third eNode B onboard the third satellite SAT3 from the first satellite SAT1 (e.g. SAT ID) or an indication of a cell served by the third eNode B onboard the third satellite SAT3 (e.g. PCI).

The RRC connection release message may comprise an indication to attempt to resume the RRC connection via the third eNode B onboard the third satellite SAT3. The indication may comprise a cause set to “resume_store_forward”.

The UE may store the resume ID associated with the UE context. The UE may suspend the RRC connection via the first eNode B onboard first satellite SAT1.

The UE context may not be available to the second eNode B onboard the second satellite SAT2 but the UE context may be available to the third eNode B onboard the third satellite SAT3

In an implementation, the UE may not attempt to resume the RRC connection via the second eNode B onboard the second satellite SAT2. The EPC may abstain from sending data for the UE to the second eNode B onboard the second satellite SAT2. However, this may be difficult for the EPC to know that UE context may not be available to the second eNode B onboard the second satellite SAT2 when the first eNode B onboard the first satellite SAT1 is not connected with the EPC and therefore cannot obtain such information from the first eNode B onboard the first satellite SAT1.

In another implementation, the UE context may not be available to the second eNode B onboard the second satellite SAT2. The UE may attempt to resume the RRC connection via the second eNode B onboard the second satellite SAT2. The attempt to resume the RRC connection via the second eNode B onboard the second satellite SAT2 may fail. The UE may store the resume ID associated with the UE context received in the RRC connection release message from the first eNode B onboard the first satellite SAT1. The UE may use the resume ID to subsequently re-attempt to resume the RRC connection via the second eNode B onboard the second satellite SAT2 or to attempt to resume the RRC connection via the third eNode B onboard the third satellite SAT3.

The UE may store the resume ID along with one or more parameters.

The UE may store the resume ID associated with the UE context along with a timer parameter indicating a time to use the resume ID to re-attempt to resume the RRC connection via the second eNode B onboard the second satellite SAT2 or to attempt to resume the RRC connection via the third eNode B onboard the third satellite SAT3.

The UE may store the resume ID associated with the UE context along with a maximum number of tries parameter indicating a maximum number of times to use the resume ID to re-attempt to resume the RRC connection via the second eNode B onboard the second satellite SAT2 or to attempt to resume the RRC connection via the third eNode B onboard the third satellite SAT3.

The UE may store the resume ID associated with the UE context along with a maximum number of resume IDs parameter indicating a maximum number of IDs to be stored by the UE.

In this way, the UE may control how long and how many resume IDs can be stored by the UE.

In another implementation, the UE context may be available to the third eNode B onboard the third satellite SAT3. The UE may attempt to resume the RRC connection via the third eNode B onboard the third satellite SAT3. For example, the UE may send a RRC connection resume message to the third eNode B onboard the third satellite SAT3. The RRC connection resume message may comprise the resume ID associated with the UE context.

The UE may attempt to resume the RRC connection via the third eNode B onboard the third satellite SAT3 after receiving the RRC connection release message. As explained above, the RRC connection release message may comprise a UE context transfer time allowing the first eNode B onboard the first satellite SAT1, the EPC or a proxy to transfer the UE context to the third eNode B onboard the third satellite SAT3 has expired from the moment the RRC connection is suspended.

The UE may attempt to resume the RRC connection via the third eNode B onboard the third satellite SAT3 after receiving the RRC connection release message. As explained above, the RRC connection release message may comprise an indication of the third eNode B onboard the third satellite SAT3 from the first satellite SAT1 (e.g. SAT ID) or an indication of a cell served by the third eNode B onboard the third satellite SAT3 (e.g. PCI).

The UE may attempt to resume the RRC connection via the third Node B onboard the third satellite SAT3 after receiving a paging message from the third Node B onboard the third satellite SAT3. The paging message may be a specialized or dedicated paging message.

The paging message may comprise an indication that the UE can continue UL transmission to the EPC via the third eNode B onboard the third satellite SAT3 or that the third eNode B onboard the third satellite SAT3 has feedback for a previous UL transmission to the EPC via the first eNode B onboard the first satellite SAT1.

This may be covering the case where the UE sent data in a previous UL transmission via the first satellite SAT1 and where the application which send the data may be expecting feedback from the EPC or from the application at the other end to the UE. The third satellite SAT3 may be carrying this feedback from the EPC to the UE.

The third eNodeB onboard the third satellite SAT3 may be carrying application layer feedback to some application layer data, which the UE previously sent to the EPC via the first eNode B onboard the first satellite SAT1. The first eNode B onboard the first satellite SAT1 may have provided the data to the EPC. The EPC may have obtained an application feedback from an application layer sink (e.g. a database or server). The application layer feedback may be transferred from the EPC to the third eNodeB onboard the third satellite SAT3 such that the third eNodeB onboard the third satellite SAT3 can provide the application layer feedback to the UE

The paging message may comprise an indication that the UE context is available to the third eNode B onboard the third satellite SAT3.

The paging message may comprise an indication to attempt to resume the RRC connection via the third eNode B onboard the third satellite SAT3. The indication may comprise a flag bit (e.g. Resume Flag) set to ‘1’ or ‘0’ to indicate per UE ID of a paging record to attempt to resume the RRC connection via the third eNode B onboard the third satellite SAT3 or to attempt to setup a new RRC connection via the third eNode B onboard the third satellite SAT3. The flag bit may be added to TS 36.331 as follows.

The paging message may comprise a resume ID delivered via the EPC or a proxy to the third satellite SAT3 that the UE can then match to the resume ID associated with the UE context stored on the UE.

“Paging ::= SEQUENCE {
pagingRecordList PagingRecordList OPTIONAL, -- Need ON
systemInfoModification ENUMERATED {true} OPTIONAL, -- Need ON
etws-Indication ENUMERATED {true} OPTIONAL, -- Need ON
nonCriticalExtension Paging-v890-IEs OPTIONAL
}
PagingRecordList ::= SEQUENCE (SIZE (1..maxPageRec)) OF PagingRecord
PagingRecord ::= SEQUENCE {
ue-Identity PagingUE-Identity,
cn-Domain ENUMERATED {ps, cs},
ResumeFlag BOOLEAN
...
}
PagingUE-Identity ::= CHOICE {
s-TMSI S-TMSI,
imsi IMSI,
...,
ng-5G-S-TMSI-r15 NG-5G-S-TMSI-r15,
fullI-RNTI-r15 I-RNTI-r15
}”

Alternatively, the UE context may not be available to the second eNode B onboard the second satellite SAT2 and the UE context may also not be available to the third eNode B onboard the third satellite SAT3.

In an implementation, when the third eNodeB onboard the third satellite SAT3 is connected to the EPC, the UE may setup a new RRC connection via the third eNodeB onboard the third satellite SAT3. For example, the UE may send a RRC connection setup message to the third eNodeB onboard the third satellite SAT3. The RRC connection may be a RRC connection for non-access stratum based recovery. The EPC (i.e. GW) may clean up prior UE context stored by the third eNodeB onboard the third satellite SAT3.

In another implementation, when the third eNodeB onboard the third satellite SAT3 is not connected to the EPC, the UE may wait for the UE context to be available to a fourth eNodeB onboard a fourth satellite SAT4 and may attempt to resume the RRC connection via the fourth eNodeB onboard the fourth satellite SAT4. For example, the UE may send a RRC connection resume message to the fourth eNode B onboard the fourth satellite SAT4.

In another implementation, when the third eNodeB onboard the third satellite SAT3 is not connected to the EPC, the UE may wait for a fourth eNodeB onboard a fourth satellite SAT4 to be connected to the EPC and may setup a new RRC connection via the fourth eNodeB onboard the fourth satellite SAT4. The UE may send a RRC connection setup message to the fourth eNode B onboard the fourth satellite SAT4.

In another implementation, when the third eNodeB onboard the third satellite SAT3 is not connected to the EPC, the UE may setup a new RRC connection via the third eNodeB onboard the third satellite SAT3. The UE may send a RRC connection setup message to the third eNode B onboard the third satellite SAT3. The UE may wait for the third eNodeB onboard the third satellite SAT3 to be connected to the EPC to complete the setup of the new RRC connection via the third eNodeB onboard the third satellite SAT3.

The first eNodeB onboard the first satellite SAT1 may provide a time (i.e. delay) to complete the setup of the new RRC connection via the third eNodeB onboard the third satellite SAT3 when the first eNodeB onboard the first satellite SAT1 instructs the UE to suspend the RRC connection. The time (i.e. delay) to complete the setup of the a new RRC connection via the third eNodeB onboard the third satellite SAT3 may be provided in the RRC connection release message.

When the UE supports a control plane (CP) solution where the packets can be delivered using NAS security keys, the UE may setup RRC connection for sending packets using NAS security keys via the third eNode onboard the third satellite SAT3. In this case the EPC may ensure that it does not release the security keys provided to (R)AN for UP solution. In other words, the EPC may ensure co-existence of UP and CP based solution for this scenario. If the third eNode onboard the third satellite SAT3 is not connected to the EPC, packets may be buffered by the third satellite SAT3 to allow the EPC (i.e. GW) to subsequently confirm the security of packets. The EPS may configure this ‘switch to CP solution’ with conditions. The conditions may be based on priority of packets and/or a number of packets.

When the UE moves out of the coverage area of the first eNode B onboard the first SAT1, the UE may perform a tracking area update (TAU) and may indicate its presence in a new area to the first eNode B onboard the first SAT1. The new area may be a tracking Area a coverage area of the third eNodeB onboard the third satellite SAT3 indicated in the RRC release message, a coverage area of a cell served by the third eNodeB onboard the third satellite SAT3 indicated in the RRC release message or other.

After performing the TAU the UE may wait for the UE context to be available in the new area. The UE may know the context is available based on a paging message. For uplink oriented data, the EPC may respond to the TAU with an “estimated time until context is available in new TAU” parameter, which would allow the UE to postpone the RRC connection resume procedure accordingly.

When the UE has high priority data (e.g. emergency call or exception data) the UE may attempt to setup a new RRC connection via the third eNode B onboard the third satellite SAT3 as soon as possible without attempting to resume the RRC connection via the third eNode B onboard the third satellite SAT3.

One or more aspects of this disclosure may enable the UE to use the RRC connection release (i.e. suspend) procedure and the RRC connection resume procedure, which significantly lowers the time to complete random access and initiate data transfer, as compared to the full RRC connection setup.

One or more aspects of this disclosure may enable the UE to determine when/which eNobde B onboard which satellites to use to perform RRC connection release (i.e. suspend) procedure and the RRC connection resume procedure (RRC Inactive in NR) in a store and forward operation scenario. This can be useful to avoid failures and the full RRC connection setup procedure.

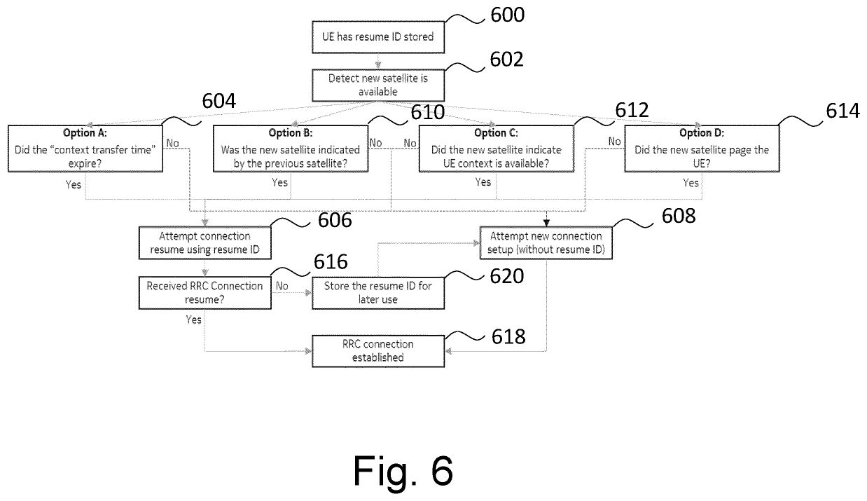

FIG. 6 is a flow chart of a method for attempting to resume a network connection via an eNode B onboard a satellite.

Initially, the UE may setup a RRC connection via the first eNode B onboard the first satellite SAT1. For example, the UE may send a RRC connection setup message to the first eNode B onboard the first satellite SAT1. The first eNode B onboard the first satellite SAT1 may store a resume ID associated with the UE context along the UE context.

The first eNode B onboard the first satellite SAT1 may instruct the UE to release the RRC connection. For example, the first eNode B onboard the first satellite SAT1 may send a RRC connection release message to the UE.

The RRC connection release message may comprise the resume ID associated with the UE context.

The RRC connection release message may comprise a UE context transfer time allowing the first eNode B onboard the first satellite SAT1, the EPC or a proxy to transfer the UE context to the third eNode B onboard the third satellite SAT3.

The RRC connection release message may comprise an indication of the third eNode B onboard the third satellite SAT3 from the first satellite SAT1 (e.g. SAT ID) or an indication of a cell served by the third eNode B onboard the third satellite SAT3 (e.g. PCI).

The RRC connection release message may comprise an indication to attempt to resume the RRC connection via the third eNode B onboard the third satellite SAT3 The indication may comprise a cause set to “resume_store_forward”.

The UE may store the resume ID associated with the UE context. The UE may release (i.e. suspend) the RRC connection via the first eNode B onboard first satellite SAT1.

In step 600, the UE may determine that the UE has the resume ID associated with the UE context stored on the UE.

In step 602, the UE may determine that the third eNode B onboard the third satellite SAT3 (i.e. new satellite) is available. That is, the UE may determine that the UE is in the coverage of the third eNode B onboard the third satellite SAT3. The UE may determine whether the UE context is expected to be available to the third eNode B onboard the third satellite SAT3.

In step 604 (option A), the UE may determine whether the RRC release message comprises a UE context transfer time and whether the UE context transfer time has expired.

If the RRC release message comprises a UE context transfer time and the UE context transfer time has expired, the method goes to step 606.

If the RRC release message does not comprise a UE context transfer time or if the RRC release message comprises a UE context transfer time and the UE context transfer time has not expired, the method goes to step 608.

In step 610 (option B), the UE may determine whether the RRC release message comprises an indication of the third eNode B onboard the third satellite SAT3 from the first satellite SAT1 (e.g. SAT ID) or an indication of a cell served by the third eNode B onboard the third satellite SAT3 (e.g. PCI).

If the RRC release message comprises an indication of the third eNode B onboard the third satellite SAT3 from the first satellite SAT1 (e.g. SAT ID) or an indication of a cell served by the third eNode B onboard the third satellite SAT3 (e.g. PCI), the method goes to step 606.

If the RRC release message does not comprise an indication of the third eNode B onboard the third satellite SAT3 from the first satellite SAT1 (e.g. SAT ID) or an indication of a cell served by the third eNode B onboard the third satellite SAT3 (e.g. PCI), the method goes to step 608.

In step 612 (option C), the UE may determine whether the UE received a paging message and the paging message comprises an indication that the UE context is available to the third eNode B onboard the third satellite SAT3.

If the UE may determine that the UE received a paging message and the paging message comprises an indication that the UE context is available to the third eNode B onboard the third satellite SAT3, the method goes to step 606.

If the UE may determine that the UE did not receive a paging message or the paging message does not comprise an indication that the UE context is available to the third eNode B onboard the third satellite SAT3, the method goes to step 608.

In step 614 (option D), the UE may determine whether the UE received a paging message from the third eNode B onboard the third satellite SAT3.

If the UE may determine that the UE received a paging message from the third eNode B onboard the third satellite SAT3, the method goes to step 606.

If the UE may determine that the UE did not receive a paging message from the third eNode B onboard the third satellite SAT3, the method goes to step 608.

In step 606, the UE may attempt to resume the RRC connection via the third eNode B onboard the third satellite SAT3. For example, the UE may send a RRC connection resume message to the third eNode B onboard the third satellite SAT3. The RRC connection resume message may comprise the resume ID.

In step 616 the UE may determine if the RRC connection has been resumed via the third eNode B onboard the third satellite SAT3. For example, the UE may determine whether a RRC connection resume complete message has been received from the third eNode B onboard the third satellite SAT3.

If the RRC connection has been resumed via the third eNode B onboard the third satellite SAT3, the method goes to 618.

If the RRC connection has not been resumed via the third eNode B onboard the third satellite SAT3, the method goes to 620.

In step 618, the RRC connection is established via the third eNode B onboard the third satellite SAT3.

In step 620, the UE may store the resume ID for later use (e.g. attempt to resume the RRC connection via the third eNode B onboard the third satellite SAT3 again). The method goes to step 608.

In step 608, the UE may attempt to setup a new RRC connection via the third eNode B onboard the third satellite SAT3. For example, the UE may send a RRC connection setup message to the third eNode B onboard the third satellite SAT3. The RRC connection setup message does not comprise the resume ID.

FIG. 7 shows a block diagram of a method for attempting to resume a network connection via a base station onboard a satellite. The method may be performed by an apparatus, for example a user equipment.

In step 700, the apparatus may suspend a network connection via a first base station onboard a first vehicle.

In step 702, the apparatus may determine that an apparatus context stored on the first base station onboard the first vehicle is expected to be available to a second base station onboard a second vehicle.

In step 704, the apparatus may attempt to resume the network connection via the second base station onboard the second vehicle.

The second base station onboard the second vehicle may or may not be connected to the network. Different scenarios may be contemplated when attempting to resume the network connection via the second base station onboard the second vehicle.

In a scenario, the second base station may be connected to the network and may not previously have received and stored the apparatus context from the first base station. The second base station may now receive and store the apparatus context from the first base station. Thus, the apparatus context may be available to the second base station. Resuming the network connection via the second base station may be successful.

In another scenario, the second base station may be connected to the network and may previously have received and stored the apparatus context from the first base station. Thus, the apparatus context may be available to the second base station. Resuming the network connection via the second base station may be successful.

In another scenario, the second base station may not be connected to the network and may have previously be connected to the network. The second base station may have previously received and stored the apparatus context. Thus, the apparatus context may be available to the second base station. Resuming the network connection via the second base station may be successful.

In another scenario, the second base station may not be connected to the network and may or may not have previously be connected to the network. The second base station may not have previously received and stored the apparatus context. Thus, the apparatus context may not be available to the second base station Resuming the network connection via the second base station may not be successful.

The apparatus may receive, from the first base station onboard the first vehicle a network connection release message. Attempting to resume the network connection via the second base station onboard the second vehicle may comprise: sending, to the second base station onboard the second vehicle; a network connection resume message.

The network connection release message may comprise an identifier associated with the apparatus context. The network connection resume message may comprise the identifier associated with the apparatus context.

The apparatus may receive, from the second base station onboard the second vehicle, a network connection resume complete message.

The apparatus may detect a failure to receive, from the second base station onboard the second vehicle, a network connection resume complete message. The apparatus may store the identifier associated with the apparatus context on the apparatus.

The apparatus may subsequently re-send, to the second base station onboard the second vehicle; the network connection resume message comprising the identifier associated with the apparatus context.

The identifier may be stored with at least one of: a time parameter indicating how long the identifier is to be stored on the apparatus before deleting the identifier from the apparatus; a maximum number of tries parameter indicating a maximum number of times the apparatus is to subsequently re-send, to the second base station onboard the second vehicle; the network connection resume message comprising the identifier before deleting the identifier from the apparatus; or a maximum number of identifiers parameter indicating a maximum number of identifiers the apparatus is to store.

The apparatus may send, to the second base station onboard the second vehicle, a network connection setup message not comprising the identifier associated with the apparatus context.

The apparatus may detect a failure to receive, from the second base station onboard the second vehicle, a network connection setup complete message when the second base station onboard the second vehicle is not connected to the network.

The apparatus may detect a failure to receive, from the second base station onboard the second vehicle, a network connection setup complete message. The apparatus may determine that the apparatus context stored on the first base station onboard the first vehicle is expected to be available to a third base station onboard a third vehicle. The apparatus may send, to the third base station onboard the third vehicle, a network connection resume message comprising the identifier associated with the apparatus context.

The apparatus may detect a failure to receive, from the second base station onboard the second vehicle, a network connection setup complete message. The apparatus may determine that a third base station onboard a third vehicle is expected to be connected to the network. The apparatus may send, to the third base station onboard the third vehicle, a network connection setup message not comprising the identifier associated with the apparatus context.

Determining that the apparatus context stored on the first base station onboard the first vehicle is expected to be available to the second base station onboard the second vehicle may comprise: determining that an apparatus context transfer time has expired from time the connection with the network is suspended.

The apparatus context transfer time may be received by the apparatus from the first base station onboard the first satellite or may be calculated by the apparatus.

Determining that the apparatus context stored on the first base station onboard the first vehicle is expected to be available to the second base station onboard the second vehicle may comprise: receiving, from the first base station onboard the first vehicle, an indication of the second base station onboard the second vehicle or an indication of a cell served by the second base station onboard the second vehicle.

The indication may indicate that the apparatus context stored on the first base station onboard the first vehicle is expected to be available to the second base station onboard the second vehicle.

The network connection release message may comprise at least one: the apparatus context transfer time; the indication of the second base station onboard the second vehicle; or the indication of the cell served by the second base station onboard the second vehicle.

Determining that the apparatus context stored on the first base station onboard the first vehicle is expected to be available to the second base station onboard the second vehicle may comprise: receiving, from the second base station onboard the second vehicle, a paging message.

The paging message may comprise at least one of: an indication that the apparatus context is available to the second base station onboard the second vehicle; or an apparatus to resume the network connection via the second base station onboard the second vehicle.

The apparatus may determine that the apparatus is moving out of coverage of the first base station onboard the first vehicle, or vice versa. The apparatus may send, to the first base station onboard the first vehicle or to the second base station onboard the second vehicle, an indication that the apparatus is moving out of coverage of the first base station onboard the first vehicle, or vice versa.

The apparatus may determine that the apparatus is moving in coverage of the second base station onboard the second vehicle, or vice versa.

The apparatus may determine that the apparatus has high priority data. The apparatus may attempt to set up the network connection via the second base station onboard the second vehicle without prior attempt to resume the network connection via the second base station onboard the second vehicle.

The first vehicle, the second vehicle and/or the third vehicle may be a satellite, a drone or a car.

The first vehicle, the second vehicle and/or the third vehicle may station may have intermittent connectivity with the network.

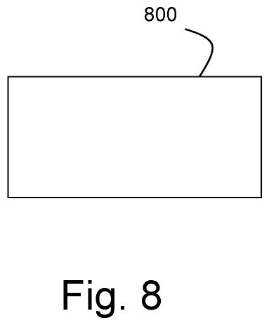

FIG. 8 shows a schematic representation of non-volatile memory media storing instructions and/or parameters which when executed by a processor allow the processor to perform one or more of the steps of the methods of FIG. 7.

It is noted that while the above describes example embodiments, there are several variations and modifications which may be made to the disclosed solution without departing from the scope of the present invention.

It will be understood that although the above concepts have been discussed in the context of an EPS (i.e. LTE), one or more of these concepts may be applied to other cellular systems, in particular 5GS or next generation systems.

It will be understood that although the above concepts have been discussed in the context of BSs onboard satellites, one or more of these concepts may be applied to BSs onboard other vehicles providing intermittent CN connectivity, such as drones, cars or other.

The embodiments may thus vary within the scope of the attached claims. In general, some embodiments may be implemented in hardware or special purpose circuits, software, logic or any combination thereof. For example, some aspects may be implemented in hardware, while other aspects may be implemented in firmware or software which may be executed by a controller, microprocessor or other computing device, although embodiments are not limited thereto. While various embodiments may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments may be implemented by computer software stored in a memory and executable by at least one data processor of the involved entities or by hardware, or by a combination of software and hardware. Further in this regard it should be noted that any procedures, e.g., as in FIG. 8, may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (ASIC), gate level circuits and processors based on multi-core processor architecture, as non-limiting examples.

Alternatively or additionally some embodiments may be implemented using circuitry. The circuitry may be configured to perform one or more of the functions and/or method steps previously described. That circuitry may be provided in the base station and/or in the communications device.

As used in this application, the term “circuitry” may refer to one or more or all of the following:
(a) hardware-only circuit implementations (such as implementations in only analogue and/or digital circuitry);
(b) combinations of hardware circuits and software, such as:
   (i) a combination of analogue and/or digital hardware circuit(s) with software/firmware and
   (ii) any portions of hardware processor(s) with software (including digital signal processor(s)), software, and memory(ies) that work together to cause an apparatus, such as the communications device or base station to perform the various functions previously described; and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example integrated device.

The foregoing description has provided by way of exemplary and non-limiting examples a full and informative description of some embodiments However, various modifications and adaptations may become apparent to those skilled in the relevant arts in view of the foregoing description, when read in conjunction with the accompanying drawings and the appended claims. However, all such and similar modifications of the teachings will still fall within the scope as defined in the appended claims.

1. An apparatus comprising at least one processor and at least one memory including instructions that, when executed by the at least one processor, cause the apparatus at least to perform:
suspending a network connection via a first base station onboard a first vehicle;
determining that an apparatus context stored on the first base station onboard the first vehicle is expected to be available to a second base station onboard a second vehicle; and
attempting to resume the network connection via the second base station onboard the second vehicle.

2. The apparatus of claim 1, wherein the instructions, when executed by the at least one processor, further cause the apparatus to perform:
receiving, from the first base station onboard the first vehicle a network connection release message; and
wherein attempting to resume the network connection via the second base station onboard the second vehicle comprises:
sending, to the second base station onboard the second vehicle; a network connection resume message.

3. The apparatus of claim 2, wherein the network connection release message comprises an identifier associated with the apparatus context; and
wherein the network connection resume message comprises the identifier associated with the apparatus context.

4. The apparatus of claim 2, wherein the instructions, when executed by the at least one processor, further cause the apparatus to perform:
receiving, from the second base station onboard the second vehicle, a network connection resume complete message.

5. The apparatus of claim 2, wherein the instructions, when executed by the at least one processor, further cause the apparatus to perform:
detecting a failure to receive, from the second base station onboard the second vehicle, a network connection resume complete message; and
storing the identifier associated with the apparatus context on the apparatus.

6. The apparatus of claim 25, wherein the instructions, when executed by the at least one processor, further cause the apparatus to perform:
detecting a failure to receive, from the second base station onboard the second vehicle, a network connection resume complete message; and
storing the identifier associated with the apparatus context on the apparatus
sending, to the second base station onboard the second vehicle, a network connection setup message not comprising the identifier associated with the apparatus context.

7. The apparatus of claim 1, wherein determining that the apparatus context stored on the first base station onboard the first vehicle is expected to be available to the second base station onboard the second vehicle comprises:
determining that an apparatus context transfer time has expired from time the connection with the network is suspended.

8. The apparatus of claim 1, wherein determining that the apparatus context stored on the first base station onboard the first vehicle is expected to be available to the second base station onboard the second vehicle comprises:
receiving, from the first base station onboard the first vehicle, an indication of the second base station onboard the second vehicle or an indication of a cell served by the second base station onboard the second vehicle.

9. The apparatus of claim 2, wherein the network connection release message comprises an identifier associated with the apparatus context:
wherein the network connection resume message comprises the identifier associated with the apparatus context; and
wherein the network connection release message comprises at least one:
the apparatus context transfer time;
the indication of the second base station onboard the second vehicle; or
the indication of the cell served by the second base station onboard the second vehicle.

10. The apparatus of claim 1, wherein determining that the apparatus context stored on the first base station onboard the first vehicle is expected to be available to the second base station onboard the second vehicle comprises:
receiving, from the second base station onboard the second vehicle, a paging message.

11. The apparatus of claim 10, wherein the paging message comprises at least one of:
an indication that the apparatus context is available to the second base station onboard the second vehicle; or
an indication that the second base station onboard the second vehicle expects the apparatus to resume the network connection via the second base station onboard the second vehicle.

12. The apparatus of claim 1, wherein the instructions, when executed by the at least one processor, further cause the apparatus to perform:
determining that the apparatus is moving out of coverage of the first base station onboard the first vehicle, or vice versa; and
sending, to the first base station onboard the first vehicle or to the second base station onboard the second vehicle, an indication that the apparatus is moving out of coverage of the first base station onboard the first vehicle, or vice versa.

13. The apparatus of claim 12, wherein the instructions, when executed by the at least one processor, further cause the apparatus to perform:
determining that the apparatus is moving in coverage of the second base station onboard the second vehicle, or vice versa.

14. A method comprising:
suspending, by a user equipment, a network connection via a first base station onboard a first vehicle;
determining, by the user equipment, that a user equipment context stored on the first base station onboard the first vehicle is expected to be available to a second base station onboard a second vehicle; and
attempting, by the user equipment, to resume the network connection via the second base station onboard the second vehicle.

15. A computer program comprising computer executable instructions which when run on one or more processors cause a user equipment to perform:
suspending a network connection via a first base station onboard a first vehicle;
determining that a user equipment context stored on the first base station onboard the first vehicle is expected to be available to a second base station onboard a second vehicle; and
attempting to resume the network connection via the second base station onboard the second vehicle.
